(19) United States
(12) Patent Application Publication
(10) Pub. No.: US 2013/0307172 A1
(43) Pub. Date: Nov. 21, 2013

(54) Method Of Converting Tear-Off Asphaltic Shingles To A Formed Product

(71) Applicants: Steven B. Seder, Colorado Springs, CO (US); William E. Pounds, Colorado Springs, CO (US); Kent A. Pugsley, Colorado Springs, CO (US); Bruce L. Shippey, Colorado Springs, CO (US)

(72) Inventors: Steven B. Seder, Colorado Springs, CO (US); William E. Pounds, Colorado Springs, CO (US); Kent A. Pugsley, Colorado Springs, CO (US); Bruce L. Shippey, Colorado Springs, CO (US)

(21) Appl. No.: 13/472,753

(22) Filed: May 16, 2012

(51) Int. Cl. B29C 67/24; B29C 71/02; B29C 37/00

(52) U.S. Cl. 264/40.1; 264/140

(57) ABSTRACT

A method of converting asphaltic shingles to a formed product, comprising the steps of providing a charge of recovered asphaltic shingles, comminuting the charge into small particles, adding to the charge a quantity of hydrated aluminosilicate, heating the charge while simultaneously mixing the comminuted charge to a homogeneous state, placing the mixed charge into molds to form the product, applying pressure to the charge in the mold for a determinable dwell time, ejecting the product from the mold, and cooling the product.

### FIELD OF THE INVENTION

The present invention relates to a process of recovering the available bitumen, fibers, aggregate, and inert materials contained in used asphalt shingles and creating useful articles therefrom.

### BACKGROUND OF THE INVENTION

The ever-growing waste stream of asphalt shingles that have been removed from existing roofs is putting an increasing burden on waste management resources. Contained within this waste stream are finitely available reusable products like asphalt, fibers, aggregate and other inert materials. The need to protect the ecosystem by recovering tons of useful materials that would normally be discarded into landfills is one object of this invention. The ecosystem is also benefited by the process of this invention by initially removing hazardous materials, such as asbestos, from the shingles being processed.

Waste shingle material is normally available from two sources. The largest and most conveniently available source is shingles removed from old or damaged roofs, referred to as “tear-off.” The second source, “Prompt scrap,” is the trimming produced during new shingle manufacture.

The idea to recover materials contained in tear-off shingles and prompt scrap is not new. A number of U.S. patents exist which disclose methods of extracting the bituminous materials for reuse in manufacturing new shingles or providing material for roadway pavement or making new products.

U.S. Pat. No. 2,128,191 relates to the use of recycled asphalt shingles (RAS) as an additive to the process of manufacturing new shingles.

U.S. Pat. Nos. 4,325,641 and 4,706,893, among others, described uses for RAS in roadway construction and repair.

RAS material is separated into its constituent parts using various methods, as those are described in U.S. Pat. Nos. 4,222,851 and 5,098,025 which use either a solvent or water to disassociate the component parts of the shingle. The process of the present invention intentionally leaves the constituent parts of the shingles in the final mix.

Some prior patents, including U.S. Pat. No. 5,221,702, suggest adding other materials like rubber from tires, polyethylene from plastic bottles, crushed brick and minerals such as limestone, basalt, quartz or granite to refine the aggregate ratio or to impose a color on the final product. The present process does not change the mechanical qualities of the final product by using aggregate additives.

### DESCRIPTION OF THE DRAWINGS

FIG. 1 is a block flow diagram of the initial inspection phase of the process of the present invention.

FIG. 2 is a block flow diagram of the second phase of the process through the heating step.

FIG. 3 is a block flow diagram of the last phase of the process where the asphaltic slurry is loaded into and removed from molds for the purpose of forming a useful article.

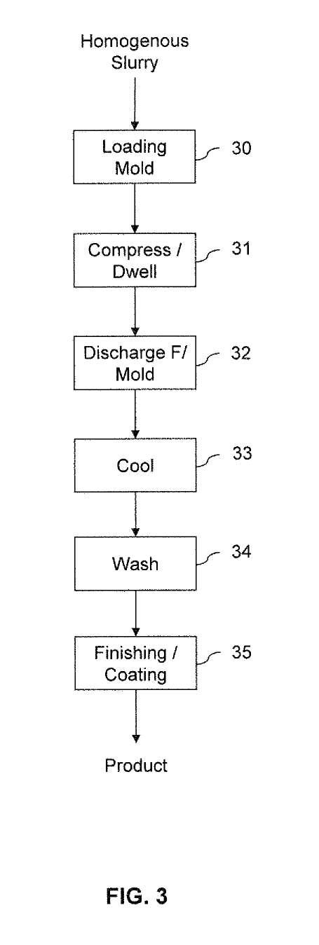

### DETAILED DESCRIPTION OF PREFERRED EMBODIMENT

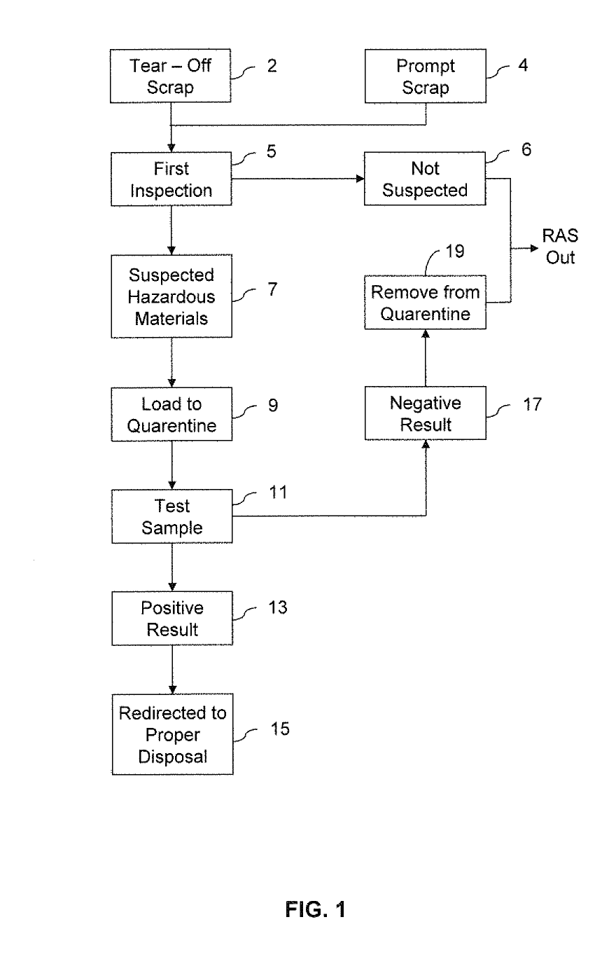

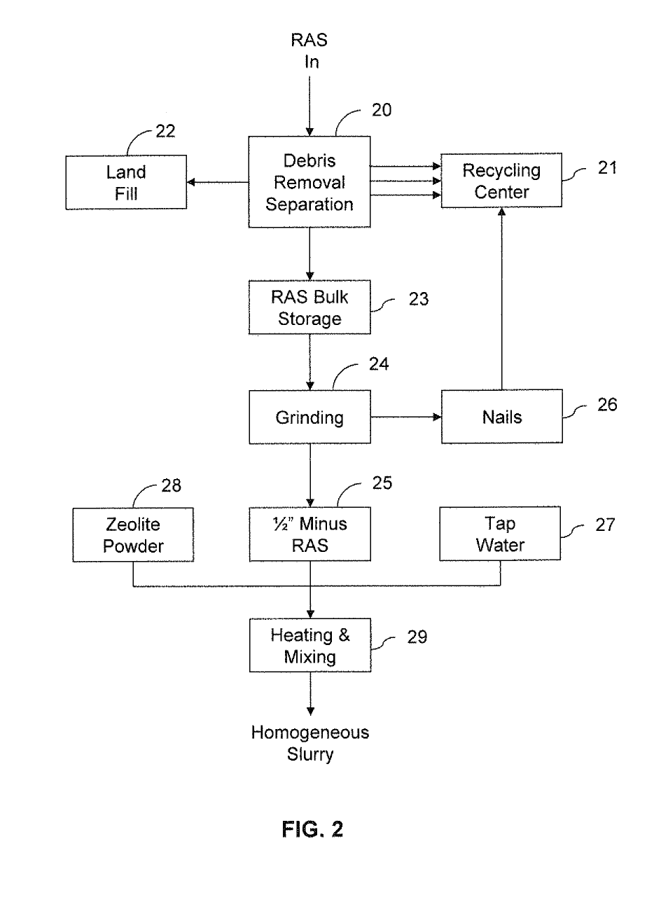

Referring first to FIG. 1 of the drawings, the raw material for the conversion process, tear-off and prompt scrap 2 and 4 are inspected at 5 for the presence of hazardous materials, such as asbestos. The raw material that is not suspected of containing hazardous material 6 is sent directly to the first step of the second phase, debris removal and separation 20 (FIG. 2). The batch or lot of raw material 7 that is suspected of containing hazardous material is quarantined at 9 and a sample of the lot is tested at 11 to positively identify suspected substances. If the test sample is positive for hazardous material 13, the quarantined batch is redirected to a proper disposal 15. If the tested sample returns a negative result 17, the batch is removed from quarantine 19 and sent to the first step of the second phase, debris removal and separation 20.

The second phase of the conversion process begins at 20 with the removal from the RAS of foreign materials such as aluminum, steel, plastic and construction debris. This material is collected and sent to an appropriate recycling center 21. Unusable debris is directed to a land fill 22. Preferably, the output of the separation step contains less than one percent by weight of deleterious material.

The “clean” RAS may, if necessary, be stored for processing at a later time at step 23. Whether taken from storage or directly from the separation stage, a charge of the clean RAS is placed into a grinder 24 where the charge of tear-off and/or prompt scrap is comminuted to a mix of small sized particles, preferably of less than one half inch in width 25. The grinder can be any one of many commercially available grinders that incorporate an exit conveyor having an electro-magnetic final roller 26 that attracts and redirects the small steel particles and roofing nails that may remain in the mix.

The charge of comminuted shingles 25 is transferred to a heating and mixing vessel where the amount of tap water 27 necessary to form slurry is added. In addition to the water, a quantity of aluminosilicate (zeolite) that is approximately two percent (2%) by weight is added to the slurry at 28. At step 29 the slurry is heated to a temperature of between 225 and 275 degrees Fahrenheit, while at the same time being physically agitated by a stirring or mixing device.

The formation of the slurry and the heating and mixing functions 29 are significant steps in achieving the ecosystem protection objectives of the invention. Avoiding high temperature in the slurry precludes the release of polycyclic aromatic hydrocarbons (PAH) and volatile organic compounds (VOC) that are known to be hazardous to health.

As the bitumen melts in the heating step 29 with increased temperature, the solids (aggregate/ceramic) contained in the RAS are mechanically released from the paper or fiberglass matting. Gravity causes the heavier solids to settle out due to sedimentation and the asphalt's increased viscosity which requires mechanical agitation to distribute the solids homogeneously throughout the slurry. The heat added to the closed system also induces a measure of thermodynamic entropy which, when controlled, increases the tendency of the process reaction to become entropically favored to proceed in a particular direction.

The goal of the process is to change the RAS and zeolite mixture from its initial condition to a homogeneous mixture with a uniform dispersion of the base materials which can be acted on by pressure in the third phase to change the state of the slurry material into a useful article.

The zeolite creates a catalysis effect on the chemical reaction in the bituminous slurry (which is basically an ion exchange) because the cations are free to migrate in and out of the zeolite structures which are tiny channels formed by eight tetrahedrally coordinated silicon or aluminum atoms and eight oxygen atoms which measure around six angstroms. This structure mechanically sets the maximum size of the molecular or ionic species that can enter the pores and limits the absorption to water molecules which can then evaporate with continued heating and provide a micro-stirring effect on the RAS slurry. The zeolite thus provides a mechanism for the reaction to successfully occur with lower activation energy. The end result of the heating and mixing step is a homogeneous mixture of the constituent parts of the recovered asphaltic shingles comprising approximately 97% recovered and reclaimed materials after deducting 2% for the aluminosilicate minerals added and the 1% inert deleterious materials contained in the mixture.

The third phase of the process begins with loading the homogenous slurry into molds 30 for shaping the final product. Pressure on the slurry in the molds, in excess of 4000 pounds per square inch, with a dwell time of at least three seconds at 31, serves to stabilize and fix the solids within the slurry. The pressure on the slurry in the molds increases the kinetic energy of the its particles which in turn increases the number of collisions between reactants in the slurry. This increases the possibility of successful molecular collisions and shortens the time for all of the material to have been acted upon by the reaction. This feature contributes to lowering the amount of heat necessary to obtain the same chemical reaction.

Following the application of pressure on the contents of the mold, the article is discharged from the mold at step 32. The resultant solid homogeneous material created after the material is cooled at step 33 is mechanically stronger due to the absence of gas pockets that reduce the final material's mechanical strength.

The final steps of the process are washing the cooled product at 36 and applying the desired finish or coating to the article at 38.

What is claimed is:

1. A method of converting asphaltic shingles to a formed product, comprising the steps of,
providing a charge of recovered asphalt shingles,
comminuting the charge into small particles,
adding to the charge a quantity of hydrated aluminosilicate,
heating the charge while simultaneously mixing the comminuted charge to a homogeneous state,
placing the mixed charge into molds to form the product,
applying pressure to the charge in the mold for a determinable dwell time,
ejecting the product from the mold, and
cooling the product.

2. The method of claim 1 where the step of providing a charge of recovered asphalt shingles includes separating hazardous materials from the charge.

3. The method of claim 2 where the step of providing a charge of recovered asphalt shingles further includes removal of aluminum, steel, plastic and debris from the charge.

4. The method of claim 2 where the step of comminuting the charge includes reducing the size of the particles to less than one half inch.

5. The method of claim 4 where the step of comminuting the charge further includes removing nails from the charge by magnetic means.

6. The method of claim 4 where the step of heating the charge is to a temperature of between 225 and 275 degrees F.

7. The method of claim 6 where the step of applying pressure to the charge in the mold includes pressure of at least 4,000 pounds per square inch for a dwell time of at least three seconds.

8. A method of converting asphaltic shingles, comprising the steps of,
providing a charge of tear-off asphaltic shingles,
removing from said charge suspected hazardous materials,
testing the suspected materials,
rejecting positively tested materials,
removing foreign materials from negatively tested materials and not suspected materials,
grinding the charge,
creating a slurry of the ground charge by adding water and aluminosilicate,
heating the slurry to a temperature of less than 300 degrees F.
agitating the heated slurry,
loading the homogeneous slurry into a product mold,
applying pressure to the slurry in the mold to form a sold mass, and
ejecting the solidified mass from the mold.

9. The process of creating a homogeneous slurry whose initial constituent components are predominately solid bitumen and a lesser quantity of aggregate including the steps of,
creating a slurry by adding water to a mix of comminuted bitumen and aggregate,
adding to the slurry a catalyst of at least two percent by weight of aluminosilicate,
heating the slurry to a Fahrenheit temperature of not more than 300 degrees, and
agitating the slurry.

10. The process of claim 9 where the solid bitumen comprises at least 97% of the slurry by weight.

11. The process of claim 10 where the aggregate comprises ceramic and solid materials included in asphaltic shingles.

12. The process of claim 10 where the Fahrenheit temperature of the slurry is between 225 and 275 degrees.
